(19) United States
(12) Patent Application Publication
(10) Pub. No.: US 2023/0359242 A1
(43) Pub. Date: Nov. 9, 2023

(54) PROVIDING WORKSPACE CONTINUITY

(71) Applicant: Dell Products L.P., Round Rock, TX (US)

(72) Inventors: Gokul Thiruchengode Vajravel, Bangalore (IN); Vivek Viswanathan Iyer, Austin, TX (US)

(21) Appl. No.: 17/739,704

(22) Filed: May 9, 2022

(51) Int. Cl. G06F 1/16; G06F 21/73

(52) U.S. Cl. CPC G06F 1/1632; G06F 1/1684; G06F 21/73

(57) ABSTRACT

Workspace continuity can be provided. When a user connects a user computing device to peripherals to form a workspace, a configuration for the workspace can be selected and automatically applied to the workspace. The configuration can be selected based on identifiers of the user, a user computing device, and the workspace.

### CROSS-REFERENCE TO RELATED APPLICATIONS

N/A

### BACKGROUND

A user may oftentimes use his or her user computing device in a workspace. In this context, a workspace can be viewed as an environment that includes a user computing device (e.g., a laptop) and peripherals that are connected to the user computing device. Such peripherals may commonly include external displays, a keyboard, a mouse, a webcam, a printer, a speaker, a fingerprint scanner, etc. Oftentimes, a workspace may include a wired or wireless dock by which the user computing device connects to some or all the peripherals.

A user may oftentimes employ multiple workspaces. For example, a user may use a workspace at work and a workspace at home. As another example, a user may use multiple workspaces at work such as one workspace at his or her desk and another workspace in a lab. Workspaces may oftentimes be used for hybrid work scenarios. For example, a business may have an office space that includes hoteling cubes that can be assigned to, reserved by, or otherwise utilized by the business’s employees as workspaces. In such cases, the business may allow its employees to use whichever workspaces may be available at any given time. As a further example, the same user may connect different user computing devices to the same set of peripherals such as when using different laptops for different purposes at work. Accordingly, it is common for a user to form workspaces by connecting a user computing device to different sets of peripherals, whether via a dock, directly, or both, and by connecting different user computing devices to the same set of peripherals.

When a user employs multiple workspaces, it can be tedious to configure each workspace to suite the user’s preferences. For example, if a user works in a hoteling environment, he or she may have to configure preferences each time a different workspace is used. Such preferences may include setting the primary display, defining the order/sequence of displays, defining the placement of applications within the display(s), defining peripheral preferences such as whether to use a webcam of the user computing device or an external webcam, etc.

### BRIEF SUMMARY

The present invention extends to systems, methods, and computer program products for providing workspace continuity. When a user connects a user computing device to peripherals to form a workspace, a configuration for the workspace can be selected and automatically applied to the workspace. The configuration can be selected based on identifiers of the user, a user computing device, and the workspace.

In some embodiments, the present invention may be implemented as a method for providing workspace continuity. It can be detected when a user computing device has been connected to a workspace. A workspace identifier for the workspace can be obtained. Based on the workspace identifier, a configuration for the workspace can be selected. The configuration to the workspace can then be applied.

In some embodiments, the present invention may be implemented as computer storage media storing computer executable instructions which when executed by one or more processors implement a method for providing workspace continuity. In conjunction with a user connecting a user computing device to a workspace, a user identifier, a user computing device identifier, and a workspace identifier can be identified. Based on the user identifier, the user computing device identifier, and the workspace identifier, a configuration for the workspace can be selected. The configuration can then be applied to the workspace.

In some embodiments, the present invention may be implemented as a user computing device that includes one or more processors and computer storage media storing computer executable instructions which when executed by the one or more processors implement a service that is configured to provide workspace continuity. The service can detect when the user computing device is connected to a workspace. The service can use an identifier of the workspace to obtain a configuration for the workspace. The service can apply the configuration to the workspace to thereby customize peripherals of the workspace.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIGS. 1A-1C each provide an example of a computing environment in which embodiments of the present invention could be implemented;

FIGS. 2A-2E provide examples of data structures that could be used in one or more embodiments of the present invention to provide workspace continuity;

FIGS. 3A and 3B are a flow diagram representing functionality that can be performed in provide workspace continuity in accordance with one or more embodiments of the present invention; and

FIGS. 4A-4C and 5A-5F provide an example of how workspace continuity can be provided in accordance with one or more embodiments of the present invention.

### DETAILED DESCRIPTION

In this specification and the claims, the term “user computing device” should be construed as encompassing any computing device that a user uses in a workspace. A user computing device may oftentimes be a laptop but could also be a desktop, a tablet, a smart phone, etc. Embodiments of the present invention are described below in the context of a Windows-based user computing device. However, embodiments of the present invention could be implemented in other operating system environments and should not be limited by or to the Windows-specific examples.

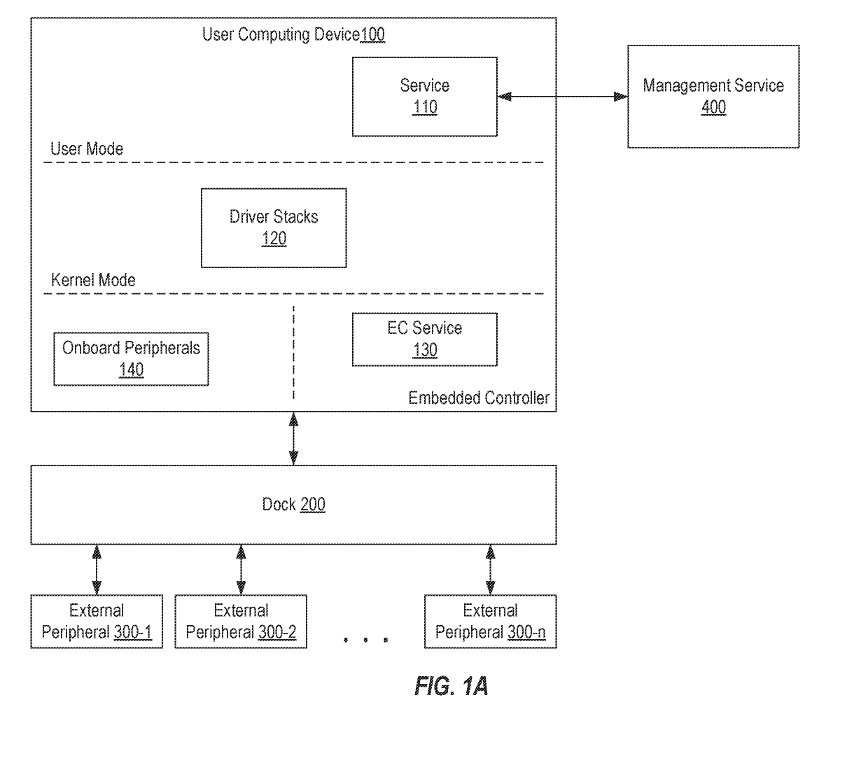

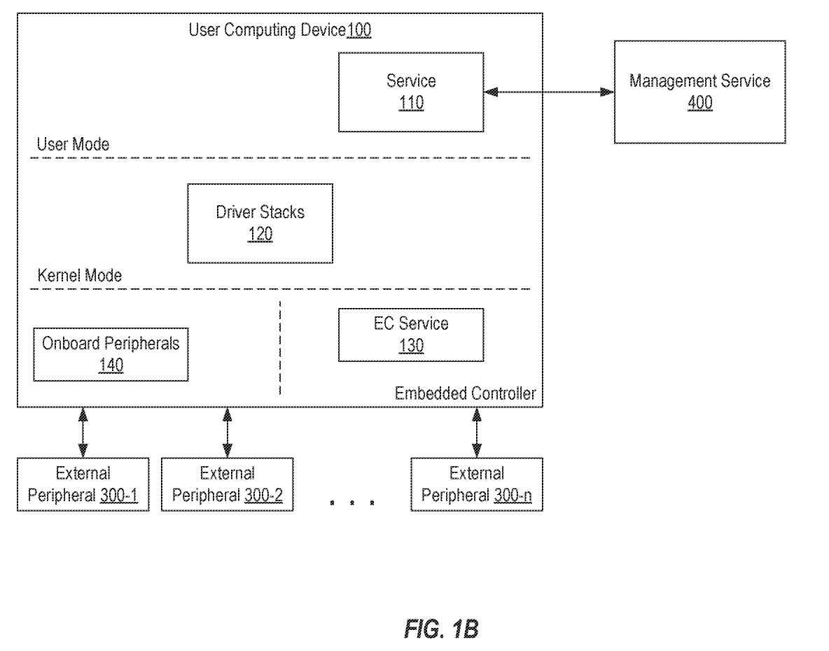

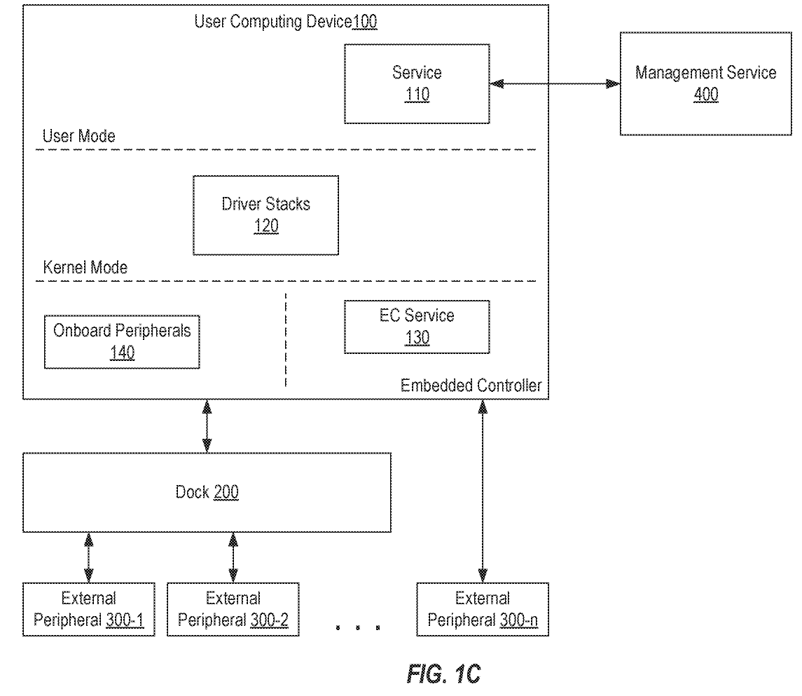

FIGS. 1A-1C each provide an example of a computing environment in which embodiments of the present invention may be implemented. The computing environment includes a user computing device 100 which includes onboard peripherals 140, possibly a dock 200, and external peripherals 300-1 through 300-n (or generally external peripheral(s) 300) and therefore represents a workspace. Onboard peripherals 140 and external peripherals 300 may be referred to collectively as peripherals. The computing environment may also include a management service 400 which may be cloud-based or otherwise network accessible (e.g., as a stand-alone web service, as part of a device management solution, etc.). However, in some embodiments, management service 400 could be omitted, with its functionality described below being performed by one or more components on user computing device 100 (e.g., service 110). FIG. 1A represents a workspace where all external peripherals 300 are connected to user computing device 100 via a dock 200. FIG. 1B represents a workspace that does not include a dock such that external peripherals 300 are connected directly to user computing device 100, whether via a wired or wireless connection. FIG. 1C represents a workspace in which some of external peripherals 300 are connected to user computing device 100 via dock 200 while others are connected directly to user computing device 100.

As an overview, whenever a workspace is formed, such as whenever a user connects user computing device 100 to a set of external peripherals 300, the workspace can be identified, and the user’s workspace preferences can be automatically applied. In this way, continuity can be provided across multiple workspaces that a user may employ.

To facilitate this workspace continuity, various components may be employed. For example, as shown in FIG. 1, a service 110 and an embedded controller (EC) service 130 may be employed on user computing device 100. Service 110 may be or may include a user mode component and may interface with management service 400 in any suitable way. EC service 130 can be a component that executes on an EC of user computing device 100 and may be configured to communicate with service 110 such as via an out-of-band channel (e.g., via network-based communications). User computing device 100 is also shown as including driver stacks 120 which correspond to the peripherals.

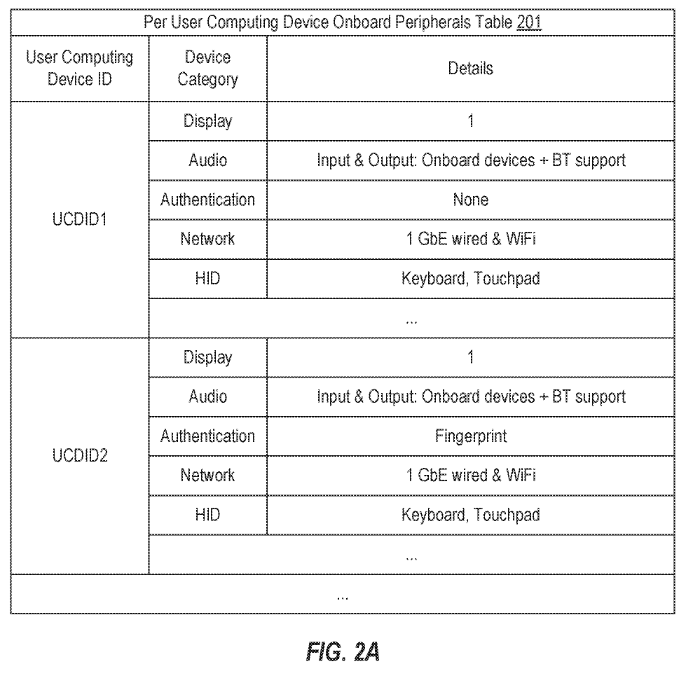

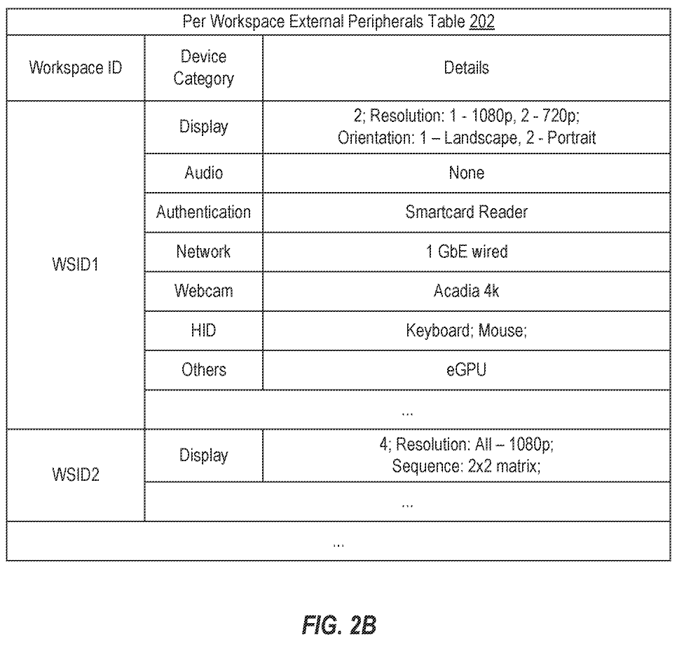

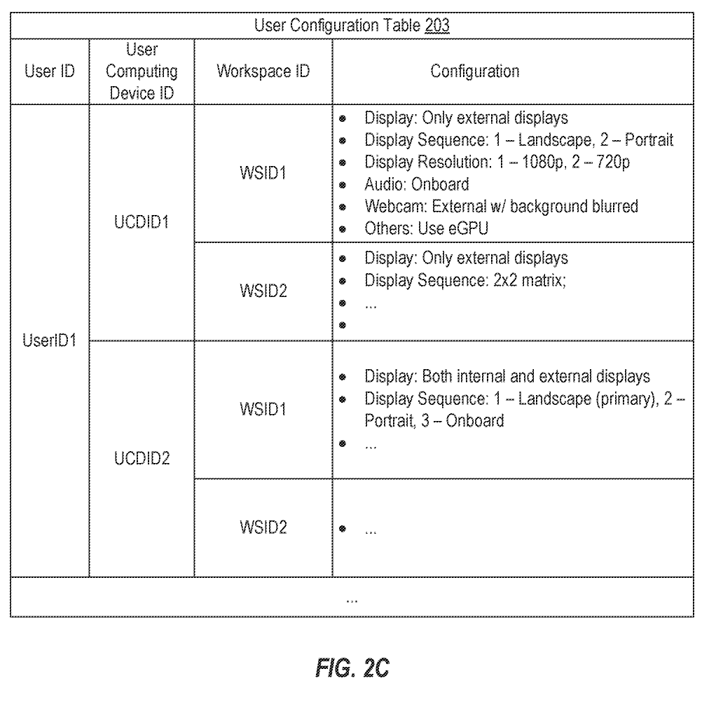

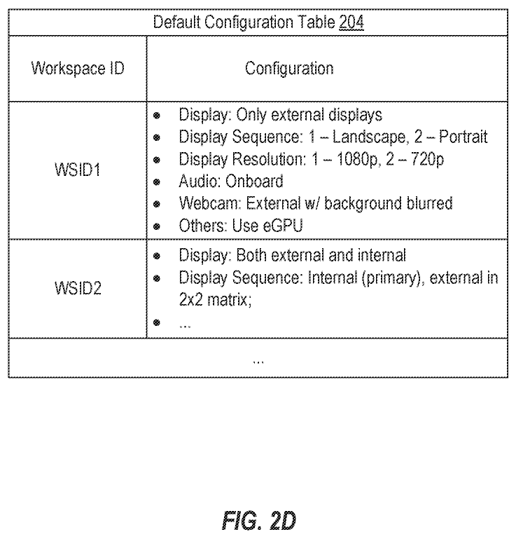

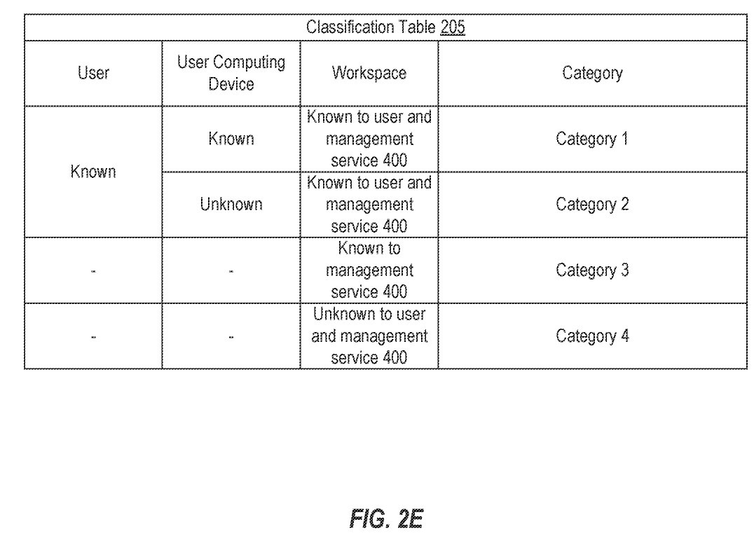

One or more data structures could be used as part of the process for providing workspace continuity. Examples of such data structures are provided in FIGS. 2A-2E. In some embodiments, these data structures could be maintained by management service 400 with assistance from service 110 as described below. FIG. 2A includes a per user computing device onboard peripherals table 201 (or onboard peripherals table 201) which identifies/defines the onboard peripherals of each participating user computing device (e.g., onboard peripherals 140 of user computing device 100). For example, in FIG. 2A, onboard peripherals table 201 includes entries for user computing devices having IDs of UCDID1 and UCDID2. Each entry can include various device categories and details about onboard peripherals in the categories (e.g., information about an onboard display, audio devices, authentication devices, network devices, HID devices, etc.).

FIG. 2B includes a per workspace external peripherals table 202 (or external peripherals table 202) which identifies/defines the external peripherals of each known workspace (e.g., external peripherals 300). For example, in FIG. 2B, external peripherals table 202 includes entries for workspaces (or sets of external peripherals that can form a workspace) having IDs of WSID1 and WSID2. As with onboard peripherals table 201, each entry in external peripherals table 202 can include various device categories and details about external peripherals in the categories (e.g., information about external displays, audio devices, authentication devices, network devices, webcams, HID devices, other devices, etc.). When a workspace includes a dock, the workspace ID could be a unique ID of the dock. The workspace ID could also be based on IDs of the external peripherals (e.g., a hash of the IDs of some or all of external peripherals 300). In short, any ID that could be used to identify a set of external peripherals that form a workspace could be used.

FIG. 2C includes a user configuration table 203 that associates configurations with a particular user, a particular user computing device, and a particular workspace. These configurations can represent the user’s preferences when he or she has connected one of his or her user computing devices to a known workspace. For example, in FIG. 2C, user configuration table 203 includes an entry for a user having an ID of UserID1 who uses user computing devices having IDs of UCDID1 and UCDID2 in workspaces having IDs of WSID1 and WSID2. FIG. 2C therefore represents a scenario where the user has used two user computing devices in the same two workspaces (i.e., has connected two user computing devices to the same dock/set of peripherals). If the user used the user computing device with the ID of UCDID2 in two other workspaces, user configuration table 203 could associate the IDs of the two other workspaces with UserID 1 and UCDID2 and define configurations specific to the two other workspaces.

FIG. 2D includes a default configuration table 204 that associates workspace IDs with default configurations. As described in detail below, default configuration table 204 could be used when a matching entry does not exist in user configuration table 203 such as when a new user connects a user computing device to a known workspace or when a user connects a new user computing device to a known workspace.

FIG. 2E includes a classification table 205 which represents logic for selecting a particular category (or use case) when a user forms a workspace. The selected category can be used to determine whether user configuration table 203, default configuration table 204, or another technique should be used to select the configurations to apply to the workspace. For example, when the user, user computing device, and workspace are all known (e.g., when the user has already connected the user computing device to the workspace), category 1 can be selected. In contrast, when the user and workspace are known but the user computing device is unknown (e.g., when the user connects a new user computing device to a workspace he or she has previously used), category 2 can be selected. If the workspace is known to management service 400 but unknown to the user (e.g., if the user has not previously connected any user computing device to the workspace such as in a hoteling scenario), category 3 can be selected. If the workspace is unknown to the user and to management service 400 (e.g., if the workspace is new), category 4 can be selected.

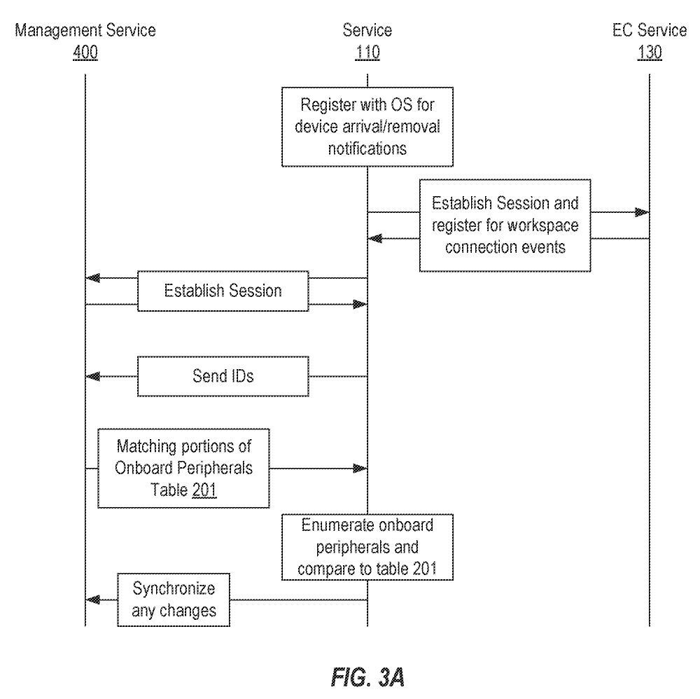

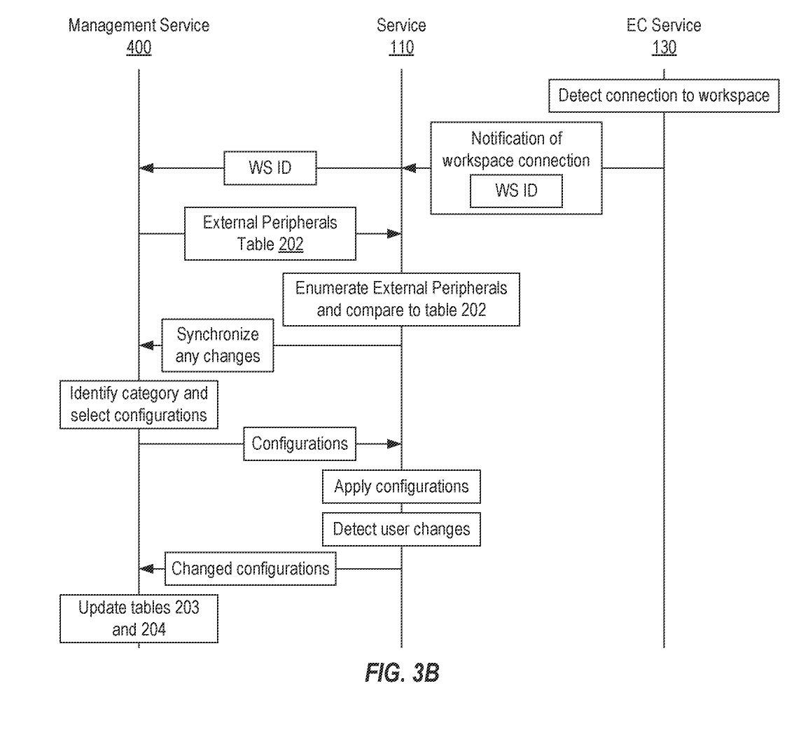

FIGS. 3A and 3B are flow diagrams representing functionality that may be performed in one or more embodiments of the present invention to provide workspace continuity when a user employs multiple workspaces. This functionality will be described in the context of FIG. 1A but could be performed when providing continuity for any workspace a user may form. FIG. 3A represents functionality that service 110 can initially perform (e.g., as part of its initialization when it is loaded on user computing device 100). Notably, service 110 may perform this functionality prior to or after user computing device 100 has been connected to a workspace (e.g., to dock 200). Service 110 can register with the operating system to be notified of device arrival/removal notifications (e.g., to be notified when onboard peripherals 140 and external peripherals 300 are enumerated). Service 110 may also establish a session with EC service 130 and register to be notified of workspace connection events (e.g., to be notified if user computing device 100 is connected to dock 200). Service 110 may also establish a session with management service 400. In this context, establishing a session can entail any functionality to enable service 110 to communicate with EC service 130 and management service 400. Service 110 may also send IDs of user computing device 100 and the user to management service 400. For example, service 110 could send UCDID1 (which is assumed to be a unique ID of user computing device 100) and UserID1 (which is assumed to be a unique ID of the user of user computing device 100) to management service 400. Using the IDs, management service 400 can identify the matching entry in onboard peripherals table 201 (e.g., the entry for UCDID1) and share the entry (or the contents of the entry) with service 110. Service 110 may enumerate onboard peripherals 140 and compare them to the matching entry in onboard peripherals table 201. If the enumerated onboard peripherals do not match the onboard peripherals listed in onboard peripherals table 201, service 110 can synchronize the changes with management service 400. For example, if an onboard peripheral 140 has been added to or removed from user computing device 100, service 110 could detect and report it to management service 400 which in turn could update onboard peripheral table 201 appropriately. In this way, management service 400 can maintain an accurate list of the onboard peripherals 140 on each participating user computing device. If user computing device 100 has not previously been connected to a workspace (e.g., when the user gets a new laptop), service 110 can report the onboard peripherals 140 to allow management service 400 to create an entry in onboard peripherals table 201.

FIG. 3B represents functionality that can be performed when the user connects user computing device 100 to a workspace. In some embodiments, EC service 130 can detect when user computing device 100 has been connected to a workspace. For example, EC service 130 could be configured to detect when user computing device 100 is connected to dock 200. Upon detecting that user computing device 100 has been connected to a workspace, EC service 130 can notify service 110. For example, EC service 130 could obtain an ID of the workspace, such as an ID of dock 200, and provide the workspace ID to service 110. Service 110 could then relay the workspace ID to management service 400. Management service 400 could then use the workspace ID to identify a matching entry from external peripherals table 202 and provide the matching entry (e.g., the list of external peripherals for the workspace) to service 110. For example, if dock 200 has an ID of WSID1, management service 400 could identify the entry in external peripherals table 202 for WSID1 and share the contents of the entry with service 110.

Service 110 can enumerate external peripherals 300 and compare the enumerated peripherals to the external peripherals the management service 400 reported. Service 110 can notify management service 400 of any changes in the external peripherals (e.g., any external peripheral 300 that has been connected to dock 200 or that is no longer connected to dock 200). If the workspace is new (e.g., if external peripheral table 202 does not include an entry matching the workspace ID reported by service 110), service 110 can report all enumerated external peripherals 300 to management service 400 to enable management service 400 to create a corresponding entry in external peripheral table 202.

Management service 400 may determine the category into which the current workspace scenario falls such as by using classification table 205. For example, management service 400 could determine if the workspace is known to the user and to management service 400. In some embodiments, management service 400 may determine that it knows the workspace by determining whether an entry exists in external peripherals table 202 for the workspace ID. In some embodiments, management service 400 may determine that the workspace is known to the user by determining whether any entries exist in user configuration table for the workspace ID. If the workspace is known to both management service 400 and the user, management service 400 may determine whether user computing device 100 is known. In some embodiments, management service 400 may do so by determining if an entry exists in user configuration table 203 for the ID of user computing device 100. If so, management service 400 can select category 1, and if not, management service 400 can select category 2.

On the other hand, if management service 400 determines that it knows the workspace but the workspace is unknown to the user, it may select category 3. This may be the case when external peripherals table 202 includes an entry for the workspace ID but user configuration table 203 does not include an entry that associates the user ID with the workspace ID. If management service 400 determines that it is not aware of the workspace, such as when no matching entry exists in external peripherals table 202, it may select category 4.

With the category selected, management service 400 can select the configurations that should be applied to the workspace to provide continuity for the user’s workspace experience. In the case where category 1 is selected, management service 400 may select the configurations from the entry in user configuration table 203 matching the IDs of the user, the user computing device, and the workspace. In the case where category 2 is selected, management service 400 may also select the configurations from user configuration table 203 but may do so from an entry matching the user ID and workspace ID. For example, management service 400 can presume that the user will prefer similar configurations as were applied when the user used a different user computing device in the workspace. In the case where category 3 is selected, management service 400 may select the configurations from an entry in default configuration table 204 matching the workspace ID. In some embodiments, configurations defined in default configuration table 204 could be based on the configurations other users have applied when using the workspace. In the case where category 4 is selected, management service 400 may use the reported external peripherals 300 that are part of the workspace to select recommended configurations. For example, management service 400 could identify a known workspace with a similar set of external peripherals (e.g., using external peripherals table 202) and may then select the configurations defined in default configuration table 204 for that known workspace.

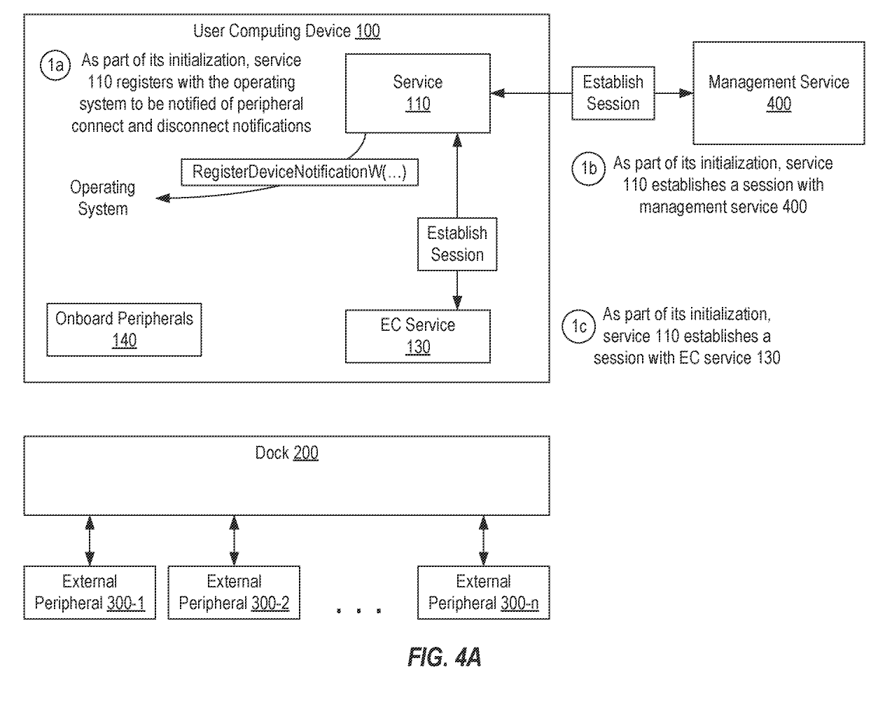

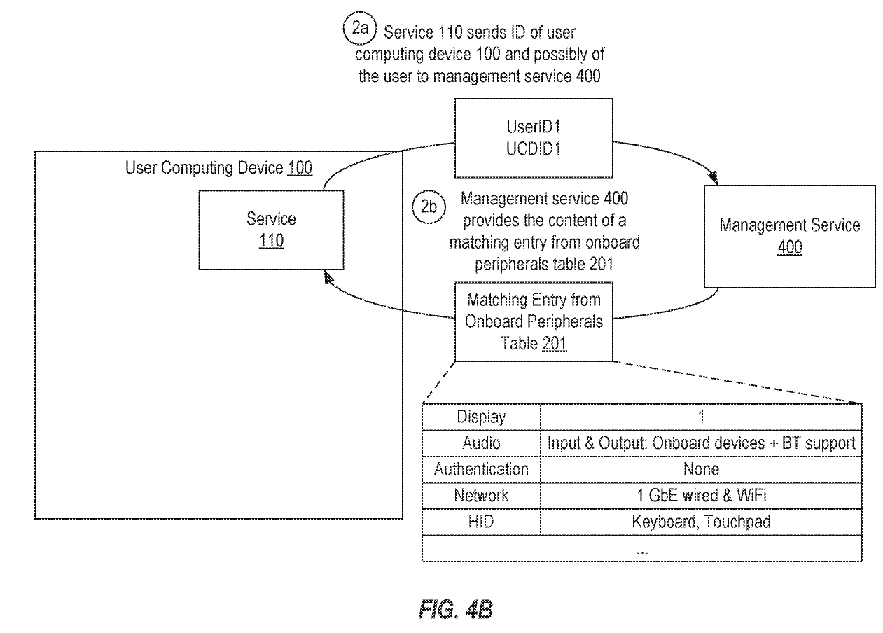

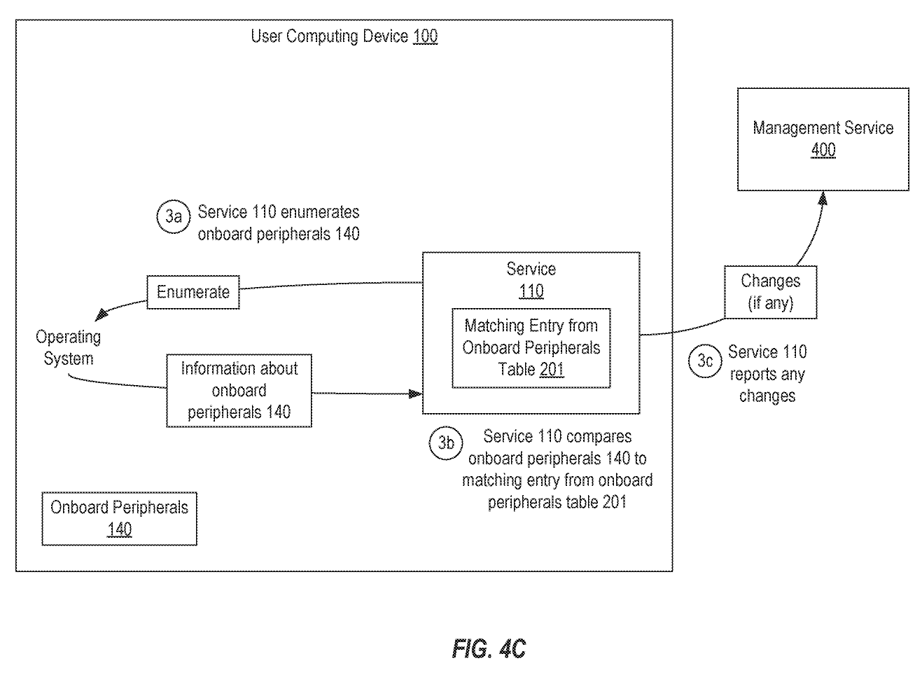

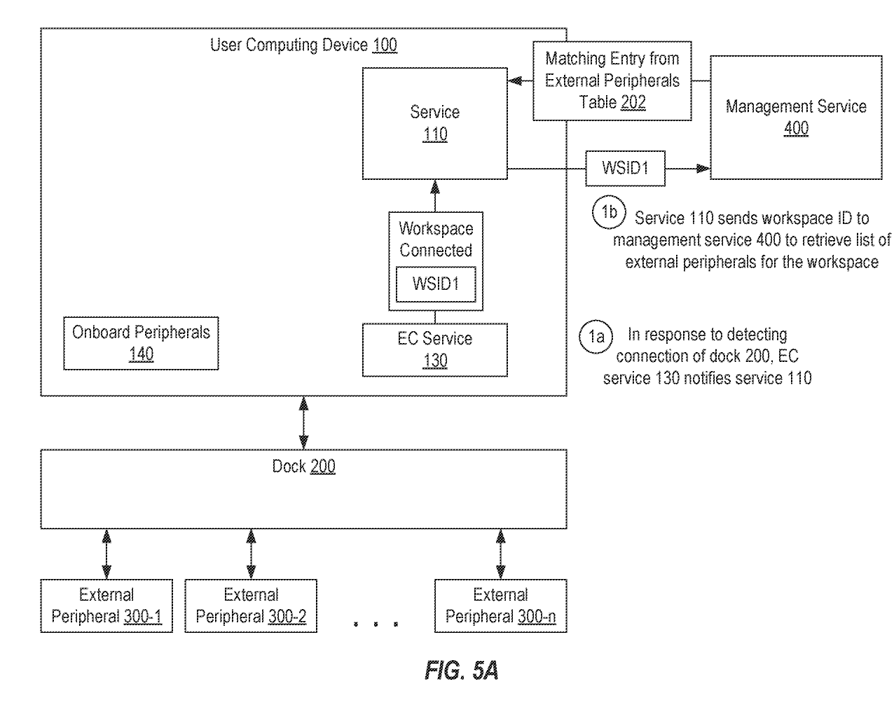

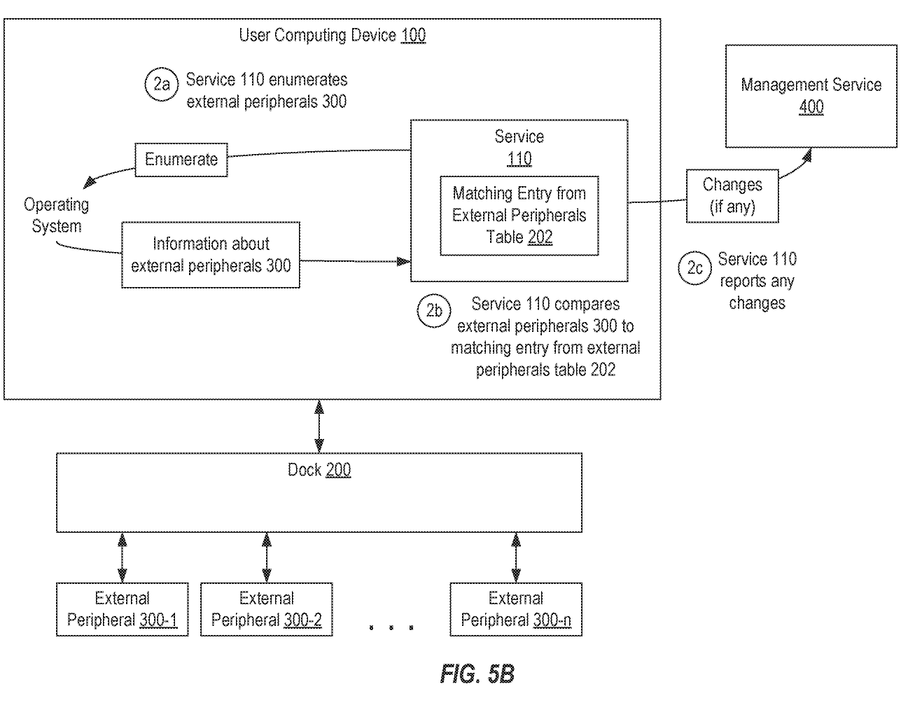

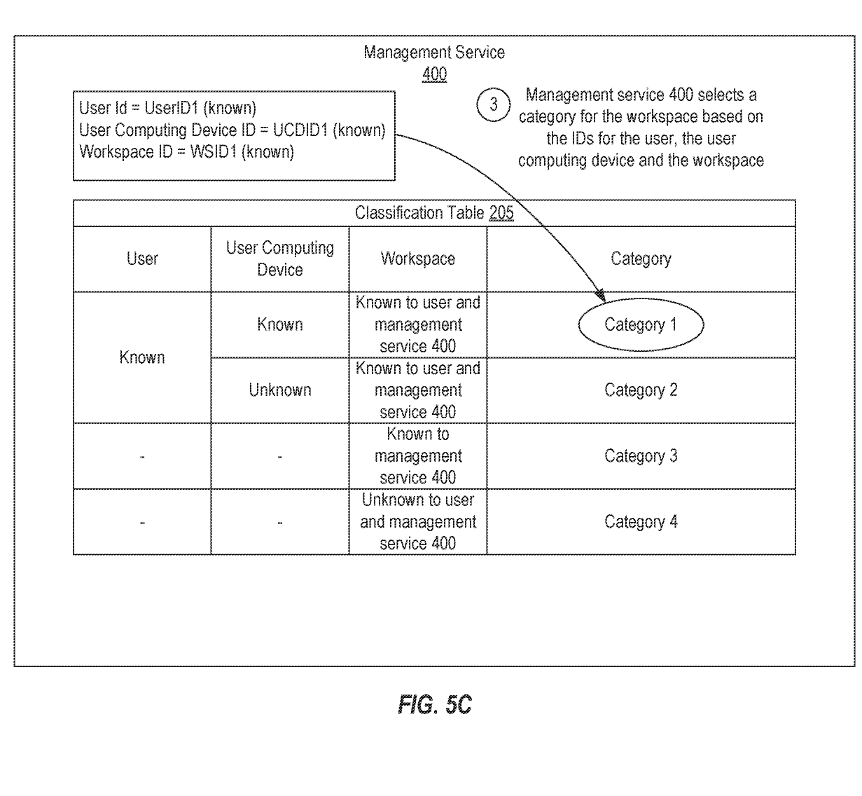

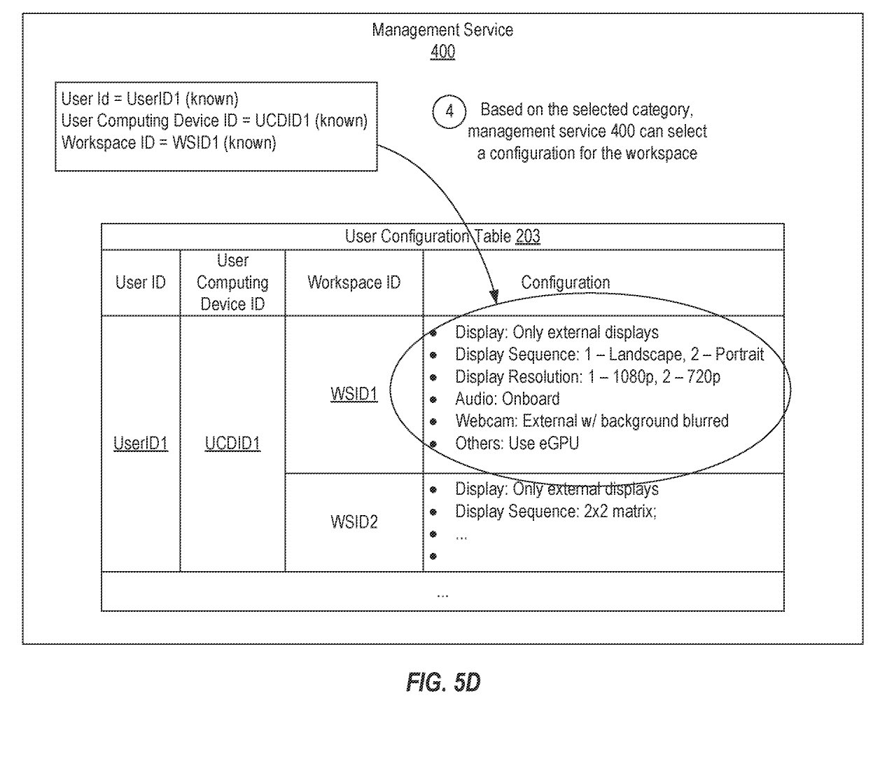

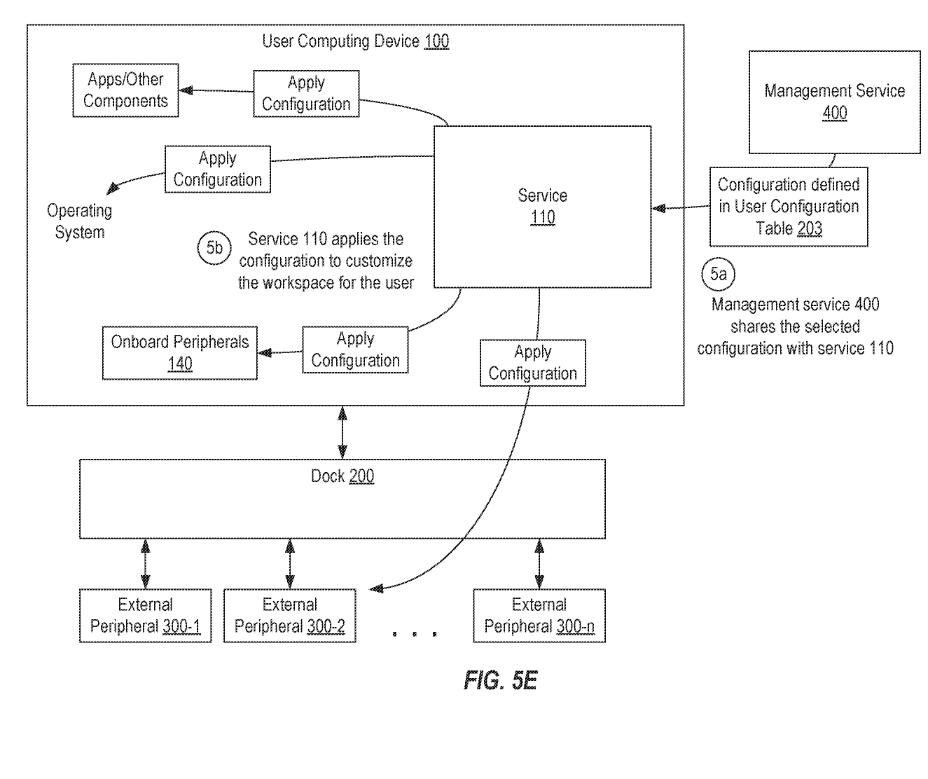

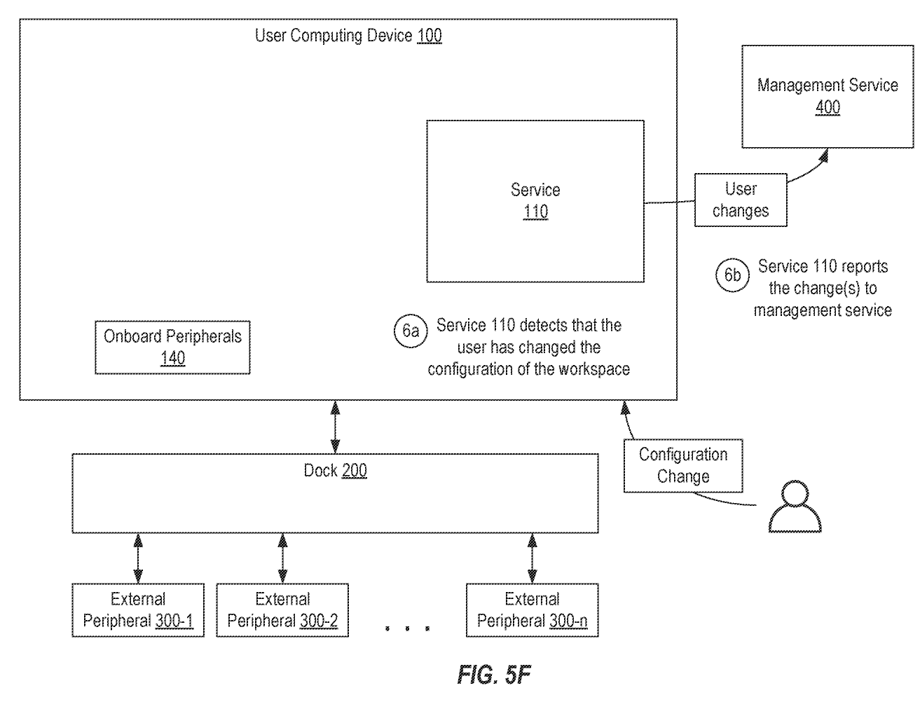

FIGS. 4A-4C and 5A-5F provide an example of how workspace continuity can be provided when a user connects a user computing device to a workspace. This example is based on the computing environment shown in FIG. 1A. FIGS. 4A-4C represent functionality that service 110 can initially perform and generally corresponds with FIG. 3A. In step 1a, service 110 can register with the operating system to be notified when peripherals are connected to or disconnected from user computing device 100. For example, service 110 could call the RegisterDeviceNotificationW function in Windows-based implementations. In step 1b, service 110 can establish a session with management service 400. In step 1c, service 110 can establish a session with EC service 130. At this point, it is assumed that the user has not yet connected user computing device 100 to dock 200.

Turning to FIG. 4B, in step 2a, service 110 can send an ID of user computing device 100 and possibly of the user to management service 400. For example, service 110 could retrieve the SMBIOS ID or Machine GUID of user computing device 100. In this example, it is assumed that the ID of user computing device 100 is UCDID1 and that the user’s ID is UserID1 both of which are reported in step 2a. In step 2b, management service 400 can return the content of a matching entry from onboard peripherals table 201. For example, management service 400 could identify the entry in onboard peripherals table 201 for UCDID1 and send the device category and details defined in this entry.

Turning to FIG. 4C, in step 3a, service 110 can enumerate (or other identify) onboard peripherals 140. Then, in step 3b, service 110 can compare the information about onboard peripherals 140 to the content of the matching entry from onboard peripherals table 201. If there are discrepancies, in step 3c, service 110 can report them to management service 400 which in turn can update onboard peripherals table 201 accordingly.

FIGS. 5A-5F represent functionality that can be performed when user computing device 100 is connected to a workspace and generally corresponds with FIG. 3B. In FIG. 5A, it is assumed that the user has connected user computing device 100 to dock 200 to which external peripherals 300 are connected. In step 1a, and in response to detecting the connection of dock 200, EC service 130 notifies service 110. As part of this notification, EC service 130 could provide a workspace ID such as an ID of dock 200. Alternatively, service 110 could retrieve the workspace ID in response to the notification. In this example, it is assumed that the workspace ID is WSID1 which is an ID of dock 200. In step 1b, service 110 sends the workspace ID to management service 400 to retrieve a list of the external peripherals for the workspace. For example, management service 400 could use the workspace ID to identify a matching entry in external peripherals table 202 and return the contents of such entry to service 110. In this example, this entry would be the first entry in external peripherals table 202 as shown in FIG. 2B.

Turning to FIG. 5B, in step 2a, service 110 can enumerate (or other identify) external peripherals 300. Then, in step 2b, service 110 can compare external peripherals 300 to the content of the matching entry from external peripherals table 202. If there are any discrepancies, in step 2c, service 110 can report them to management service 400 which in turn can update external peripherals table 202 accordingly.

At this point, management service 400 will be aware of the IDs of the user (UserID1), user computing device 100 (UCDID1), and the workspace to which user computing device 100 is connected (WSID1). In step 3, shown in FIG. 5C, management service 400 can select a category for the workspace based on such IDs. For example, management service 400 could determine that the workspace is known to it and the user based on the presence of entries matching WSID1 in external peripherals table 202 and user configuration table 203 respectively. Management service 400 could also determine that user computing device 100 is known based on the presence of an entry matching UCDID1 in onboard peripherals table 201. Accordingly, in this example, management service 400 can select category 1 for the workspace that the user has formed by connecting user computing device 100 to dock 200.

Turning to FIG. 5D, in step 4, based on the selected category, management service 400 can select a configuration for the workspace. In this example where category 1 was selected, management service 400 can access user configuration table 203 to locate an entry matching UserID1, UCDID1, and WSID1 and then retrieve the configuration defined in the entry.

Turning to FIG. 5E, in step 5a, management service 400 can share the selected configuration with service 110. Then, in step 5b, service 110 can apply the configuration to the workspace. This application of the configuration could be carried out in a variety of ways depending on the configuration. For example, management service 400 could interface with the operating system, onboard peripherals 140, external peripherals 300, and/or applications or other components. Various examples of such configurations are provided below.

Turning to FIG. 5F, after applying the configuration to the workspace, service 110 can monitor for any changes the user may make to the configuration. In step 6a, it is assumed that the user has made a change to the workspace configuration and that service 110 detects the change. In step 6b, service 110 can report the change(s) in the workspace configuration to management service 400 to enable management service 400 to update user configuration table 203 accordingly. Such changes to the workspace configuration could be in the form of a change to or deletion of an already defined preference or the addition of a new preference.

The following are various examples of how embodiments of the present invention could be implemented to provide workspace continuity. A user may have two cubicles at work. In the first cubicle, there may be two displays, one of which has an integrated webcam and microphone. In the second cubicle, there may be a single large display and an external USB headset. When using the first workspace, the user may prefer using the integrated webcam and microphone and may prefer the display with the integrated webcam and microphone as the primary display. In contrast, when using the second workspace, the user may prefer that the large display be spilt into four regions and may prefer using the onboard webcam and microphone of his user computing device. The user may also prefer having the mouse in left hand mode in any workspace. Embodiments of the present invention could be implemented to ensure that the workspaces are configured in the user’s preferred manner whenever he connects his user computing device. Also, in the user connected a different user computing device to either workspace, the same or similar configuration could automatically be applied to ensure workspace continuity.

As another example, a user may use a first user computing device in a workspace that includes two displays, one of which includes an integrated webcam and microphone. The user may prefer that the display with the integrated webcam and microphone is positioned to the left of the other display and is the primary display. Then, the user may get a second user computing device and may connect it to the same workspace. In this case, embodiments of the present invention would enable the user’s preferences to be automatically applied to customize the workspace even though the second user computing device is new.

As another example, a user may reserve a hoteling cube that includes an external USB speaker and microphone, an external webcam, two displays, a keyboard, and a mouse, all of which are connected to a USB-C dock. The user has never used the hoteling cube but other users (e.g., coworkers) have. In such a scenario, embodiments of the present invention could allow preferences to be selected and automatically applied to the workspace based on the other users’ preferences for the workspace (e.g., using default configuration table 204).

As another example, a user may reserve a new hoteling cube (i.e., a workspace that is unknown). In such a case, embodiments of the present invention could allow preferences for the workspace to be automatically defined based on the user’s preferences for other workspaces he has used (e.g., by selecting a configuration from user configuration table 203 for a workspace that is similar to the new workspace).

In summary, embodiments of the present invention can be implemented to ensure that a user has a consistent experience matching his or her preference when using multiple workspaces. In this way, the user can be relieved of the burden of configuring peripherals and associated settings each time he or she connects to workspace.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similar storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for providing workspace continuity, the method comprising:
detecting when a user computing device has been connected to a workspace;
obtaining a workspace identifier for the workspace;
based on the workspace identifier, selecting a configuration for the workspace; and
applying the configuration to the workspace.

2. The method of claim 1, wherein detecting when the user computing device has been connected to the workspace comprises detecting when the user computing device has been connected to a dock to which external peripherals are connected.

3. The method of claim 2, wherein the workspace identifier is an identifier of the dock.

4. The method of claim 1, wherein the configuration for the workspace is selected based also on an identifier of a user of the user computing device.

5. The method of claim 1, wherein the configuration for the workspace is selected based also on an identifier of the user computing device.

6. The method of claim 1, wherein the configuration for the workspace is selected based also on an identifier of the user computing device and an identifier of a user of the user computing device.

7. The method of claim 1, wherein selecting the configuration for the workspace based on the workspace identifier comprises determining that the user computing device has previously been connected to the workspace.

8. The method of claim 1, wherein selecting the configuration for the workspace based on the workspace identifier comprises determining that a user of the user computing device has previously connected a different user computing device to the workspace.

9. The method of claim 1, wherein selecting the configuration for the workspace based on the workspace identifier comprises determining that the user computing device has not previously been connected to the workspace.

10. The method of claim 1, wherein selecting the configuration for the workspace based on the workspace identifier comprises determining that the workspace is unknown.

11. The method of claim 1, wherein applying the configuration to the workspace comprises enabling or disabling one or more peripherals.

12. The method of claim 11, wherein the one or more peripherals one or both of external peripherals or onboard peripherals.

13. The method of claim 1, wherein applying the configuration to the workspace comprises configuring one or more settings of an operating system or an application pertaining to one or more peripherals.

14. The method of claim 13, wherein the one or more peripherals comprise one or more of a display or a webcam.

15. One or more computer storage media storing computer executable instructions which when executed by one or more processors implement a method for providing workspace continuity, the method comprising:
in conjunction with a user connecting a user computing device to a workspace, identifying a user identifier, a user computing device identifier, and a workspace identifier;
based on the user identifier, the user computing device identifier, and the workspace identifier, selecting a configuration for the workspace; and
applying the configuration to the workspace.

16. The computer storage media of claim 15, wherein selecting the configuration for the workspace comprises one of:
determining that the user has previously connected the user computing device to the workspace;
determining that the user has previously connected another user computing device to the workspace;
determining that the user has not previously used the workspace; or
determining that the workspace is unknown.

17. The computer storage media of claim 15, wherein selecting the configuration for the workspace comprises one of:
determining that the configuration is associated with the user identifier, the user computing device identifier, and the workspace identifier;
determining that the configuration is associated with the user identifier, an identifier of another user computing device, and the workspace identifier; or
determining that the configuration is associated with the workspace identifier but not with the user identifier or the user computing device identifier.

18. The computer storage media of claim 15, wherein applying the configuration to the workspace comprises enabling or disabling one or more peripherals.

19. A user computing device comprising:
one or more processors;
computer storage media storing computer executable instructions which when executed by the one or more processors implement a service that is configured to provide workspace continuity by performing the following:
detecting when the user computing device is connected to a workspace;
using an identifier of the workspace to obtain a configuration for the workspace; and
applying the configuration to the workspace to thereby customize peripherals of the workspace.

20. The user computing device of claim 19, wherein the service also uses an identifier of a user of the user computing device and an identifier of the user computing device to obtain the configuration for the workspace.
